(19) United States
(12) Patent Application Publication
(10) Pub. No.: US 2011/0058034 A1
(43) Pub. Date: Mar. 10, 2011

(54) Sharing of video surveillance information

(75) Inventor: John Grass, Fremont, CA (US)

(73) Assignee: Alwaysview, Inc., Fremont, CA (US)

(21) Appl. No.: 12/584,445

(22) Filed: Sep. 5, 2009

(51) Int. Cl. H04N 7/18

(52) U.S. Cl. 348/143

(57) ABSTRACT

A method of sharing the monitoring of video surveillance information between different users is provided. The video surveillance information from a user is transmitted over a network such as the Internet to a third party surveillance center. A user, or designated parties of that user, may access his own video surveillance information from the surveillance service in addition to video surveillance information that has originated from other users. Which other user video surveillance information may be accessed by a user is determined by a set of rules that are enforced by the surveillance service. The rules for allowing a user to view other users' video surveillance information may be based on geographical location, group affiliation, network of users, or otherwise. A user accessing other users' video surveillance information may or may not know these other users.

### BACKGROUND OF THE INVENTION

The present invention relates to surveillance systems, particularly to surveillance systems that enable the sharing of surveillance data between users.

Surveillance systems have been widely used for a number of years, providing security to homes and businesses. Video surveillance, in particular, has become an important tool in providing security. Video cameras have been used in a number of different surveillance applications to monitor locations instead of having an actual person physically present. The signals from video cameras used in video surveillance can be examined live by the location owners or occupants, or by hired security personnel. Alternatively, the video signals can be stored for future viewing.

The widespread availability of broadband connections to the Internet has enabled video surveillance cameras to be accessed remotely. Typically, with a web browser located anywhere on the Internet, the signal from the cameras can be viewed live or with a small delay. In addition, the video signals can be recorded locally or at an off-site location through the use of an Internet connection. If stored off-site, the recorded video signals can be accessed at a future time through an Internet connection.

While security systems have improved over the years, property theft, vandalism and personal crime has not been drastically curtailed. Changes in society such as both adults in a household working and not having extended family living together have resulted in homes being vacated for extended periods of time. Complex economic and social issues continue to cause a large number of individuals to turn to crime and victimize neighborhood residents. Businesses as well are impacted by the crime, both during business hours as well as after business hours. Limited police budgets prevent police forces from putting a complete stop to crime in neighborhoods.

What is needed is an increase in the effectiveness of security systems, and in particular video surveillance systems, to help reduce the amount of crime impacting the users of such systems.

Currently, users of surveillance systems are limited to just the surveillance information they collect on their own. What is needed in the prior art of surveillance systems is the ability for users of video surveillance systems, though only connected by a common characteristic such as living near one another (e.g. neighbors), to share their video information with each other. Such sharing of surveillance information will help increase the effectiveness of the surveillance systems.

### BRIEF SUMMARY OF THE INVENTION

This invention describes a method in which a group of users of video surveillance systems who may not know each other, yet linked together by a common characteristic such as living near one another (i.e. neighbors) can systematically share their video surveillance information with each other.

In one embodiment of this invention, a user deploys a video surveillance system at his home, capturing views of his outside property as well as the surrounding area. The views may also include views of his inside property as well. The video surveillance system consists of one or more video cameras and possibly other sensory detection equipment, as well as the capability to transmit the video surveillance information over a network such as the Internet.

The user subscribes or otherwise belongs to a surveillance service provided by a third-party company or organization. The user's video surveillance system transmits, in real-time or delayed, over a network such as the Internet, to the surveillance service center the video surveillance information. The video surveillance information may consist of video, images, audio, motion detection, and other such surveillance and user data. The surveillance service center consists of application software, computer system, storage devices and connections to the network used by its users such as the Internet.

At the surveillance service center, the video surveillance information is made available for immediate or delayed re-transmission as well as archived for future access. The user accesses the service center through a connection over a network such as the Internet. The availability of video surveillance information to the user is subject to a set of rules as established by the surveillance service.

The basis of the rules used by the surveillance service is the establishment of groups to which a user belongs. These groups may be based on geographical location, group affiliation, network of users, or otherwise. A user accessing other users' video surveillance information may or may not know these other users. In a typical scenario, a user would belong to a group based on his location. In other words, users that live in the same neighborhood would all belong to the same group. The surveillance service gives permission to each user belonging to the same group access to the video surveillance information from all the users of that group. Other rules that may be applied by the service to the access of video surveillance information are, for example, time of day, day of week access restrictions or access permission control to individual video surveillance information.

With users having access to the video surveillance information from the other users in their group, the effectiveness of the video surveillance system increases dramatically. Moreover, the security of the whole neighborhood is increased, helping reduce the amount of crime the neighborhood experiences.

One improvement in the video surveillance effectiveness through use of this invention comes from the ability of a user to have access to video surveillance information he would normally not have access to. With this additional video surveillance information, a user can better monitor live the neighborhood rather than just his immediate area. In addition, a user can have his home area monitored live by his neighbors when he is not able to be actively monitoring.

A second improvement in the video surveillance effectiveness is the availability to the user of stored video surveillance information from all the other users in his neighborhood. If an incident happens at a user's home, he can access not only the stored video surveillance information from his own video surveillance system but also the stored video surveillance information from the entire neighborhood. This assists in tracking the movements of any criminals through the neighborhood and can help lead to the arrest of the criminals. The arrest of a criminal after an incident in the neighborhood can lead to reduced incidents in the future.

One feature of modern video surveillance systems is the use of email or text alerts which consist of an email or text being sent to the user when motion or some other pre-determined event occurs. These alerts can be simple text or, in the case of emails, also contain images or video clips from the time when the event occurred. The user, through network access (Internet access for emails and mobile access for text messages), can receive the alert where ever he is, and based on the information contained in the alert, take action as required. A third improvement from this invention is the broadcasting of these alerts to all the users in the group. For example, if motion is detected in one user's backyard, while that user may not be in a position to receive or act on the alert, the other users could. Being that these other users are typically neighbors, their response could be rather quick. Their response may be to contact the authorities, investigate in-person, and/or to start monitoring the other neighborhood video surveillance information live. Thus, the effectiveness of the video surveillance system is improved by having a shared neighborhood response to an alert as provided by this invention.

A fourth improvement in the video surveillance effectiveness from this invention is the ability of users in a group to share additional information in regards to neighborhood security aside from the video security information. Examples of such information are advice and comments on security for the neighborhood. Typically such information would be exchanged through discussion groups or emails associated with the neighborhood group.

A fifth improvement in the video surveillance effectiveness from this invention is the ability to give permission to law enforcement agencies such as the police or security services to access video surveillance information from users. This permission may be pre-arranged by the service provider as part of its service terms, or the permission may be granted by the groups, or given by the individual users. With this broad neighborhood video surveillance information coming from a number of users in the same area, the tracking of criminals and suspicious activities in a neighborhood is greatly facilitated. This in turn should lead to reduced amount of crime in the neighborhood as well as the increased the sense of security for the users.

A sixth improvement in the video surveillance effectiveness from this invention is the ability to delegate the monitoring of the video surveillance information. A user of a video surveillance system can designate another person to connect to his video surveillance system in order to monitor the system on his behalf. With this invention, the designated person can monitor the video surveillance information from the entire group. Thus the likelihood that there is some user or designated person in the group monitoring the video surveillance information live increases dramatically as compared to individual video security systems. The designated person can easily be located at a remote location through use of a network connection to access the video security information.

In another embodiment of this invention, the users in the same group can be businesses rather than home occupants. Businesses would typically be located in the same vicinity of each other and thus share in the security of their business area. With the shared video surveillance method as described by this invention, the businesses would benefit from the enhanced security provided by the sharing of video surveillance information.

In another embodiment of this invention, rather than all the video surveillance information being stored at the video surveillance service center, it remains stored at the individual user locations. The video surveillance service center, however, still controls the access a user has to other users' video surveillance information as described previously. As an example, if user 1 and user 2 belong to the same group, user 1 can access the video surveillance information located on the video surveillance system of user 2 through access permissions given by the video surveillance service center.

### BRIEF DESCRIPTION OF THE SEVERAL VIEWS OF THE DRAWING

FIG. 1 is an illustration of video surveillance at different locations using a remote video surveillance service center to store and manage the collected video surveillance information.

FIG. 2 is an illustration of one owner of a video surveillance system monitoring the video surveillance information from multiple video surveillance systems.

FIG. 3 is an illustration of an example usage of the sharing of video information method described in this invention.

FIG. 4 is an illustration of a surveillance alert from one location being broadcast from the video surveillance service center to all the locations.

FIG. 5 is an illustration of a law enforcement agency connecting to the video surveillance information of a group by using the video surveillance service center.

FIG. 6 is an illustration of a designated person monitoring the video surveillance information from all the locations within a group.

### DETAILED DESCRIPTION OF THE INVENTION

The following detailed description of the invention is provided to enable any person skilled in the art to make and use the invention and sets forth the best modes contemplated by the inventor for carrying out the invention. To those skilled in the art, it will remain readily apparent that there can be various modifications to the description. Any and all such modifications, equivalents and alternatives are intended to fall within the spirit and scope of the present invention.

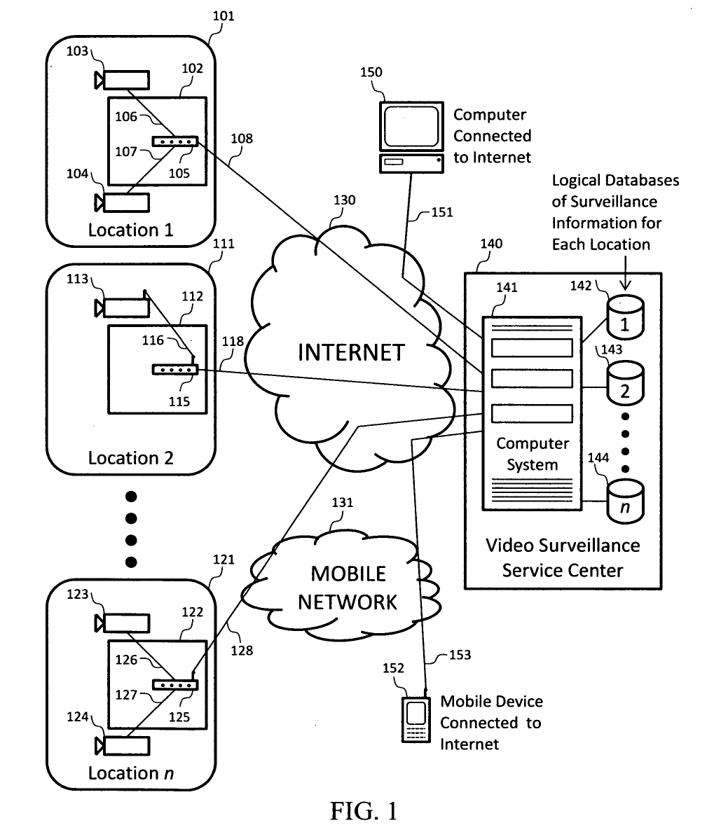

FIG. 1 is an illustration of a prior art video surveillance system that can be used in homes and businesses. The locations (e.g. 101, 111 and 121) have one or more video cameras installed (e.g. 103, 104, 113, 123 and 124) or other surveillance equipment such as motion detectors. Each of these locations 101, 111 and 121 are independent of each other which means that they have different occupants, or different business establishments owned by different business owners.

Various types of cameras may be employed, including cameras manufactured by different manufacturers. The cameras may be directly network enabled (i.e. can be connected to a computer network directly), or be analog cameras that are made network enabled through a converter device (typically a computer).

As an example, location 1 (i.e. 101) shows two network enabled video cameras connected to a computer network. The video cameras 103 and 104 are connected via network cables 106 and 107 to a router 105. The router 105 is connected via broadband connection 108 to the Internet 130, and from the Internet 130 to the video surveillance service center 140. In some cases, the local network is provided by more than just one device as shown in this example as a router 105. The local network may consist of a separate router and another device connected to the router to provide the broadband connection (e.g. DSL modem, cable modem or mobile modem).

As another example, location 2 (i.e. 111) shows one network enabled video camera connected to a computer network. The video camera 113 is connected via a wireless connection 116 to a router 115. The router 115 is connected via broadband connection 118 to the Internet 130, and from the Internet 130 to the video surveillance service center 140.

As another example, location n (i.e. 121) shows two network enabled video cameras connected to a computer network. The video cameras 123 and 124 are connected via network cables 126 and 127 to a router 125. The router 125 is connected via a wireless connection 128 to a mobile network 131, from the mobile network 131 to the Internet 130, and from the Internet 130 to the video surveillance service center 140.

The video surveillance systems at each location transmit the video surveillance information, in real-time or delayed, over a network such as the Internet 130 to the video surveillance service center 140. The video surveillance service center 140 consists of application software, a computer system 141, storage devices (142, 143 and 144) and connections to the Internet 130. The video surveillance service center 140 stores all the location, user and service information as well as the archive of all the video surveillance information. The video surveillance information may consist of video, images, audio, motion detection, and other such surveillance and user data. FIG. 1 shows the archive of the video surveillance information broken down into logical databases 142, 143 and 144 associated with each location 101, 111 and 121 respectively. At the video surveillance service center, the video surveillance information is made available for immediate or delayed re-transmission as well as archived for future access.

The user or users associated with each location may access their video surveillance information from the video surveillance service center through an Internet connection 151, or through a mobile connection 153 that connects a mobile device 152 to the Internet 130. The computer 150 or mobile device 152 used by the users may be located anywhere on the Internet 130 or mobile network 131.

The number of locations supported by the video surveillance service center is from 1 to n, where n can be any number. When the number n is very large, the complexity of the video surveillance service center 140 may be much higher than what has been shown in FIG. 1.

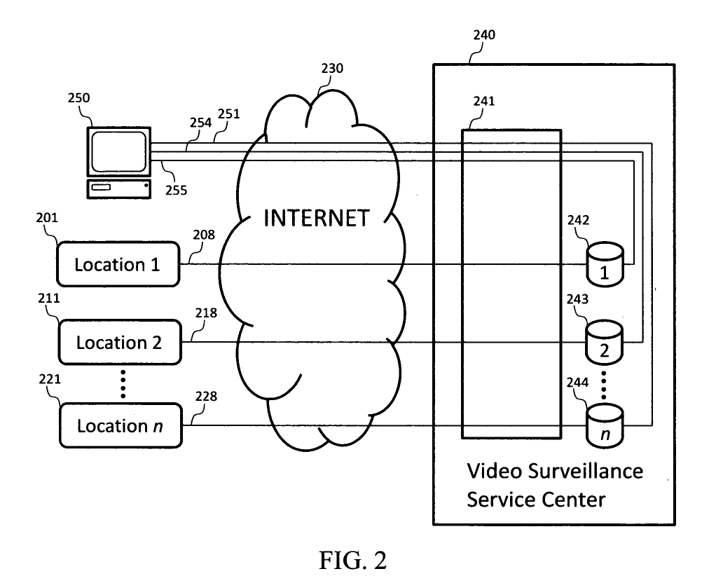

FIG. 2 illustrates a preferred embodiment of the invention. In this embodiment, video surveillance information is transmitted from the locations 201, 211 and 221, in real-time or delayed, through a network connection (208, 218 and 228) to the Internet 230, and then to the video surveillance service center 240. Each of these locations 201, 211 and 221 are independent of each other, which means that they are separate homes occupied by different people, or different business establishments owned by different business owners.

At the surveillance service server center 240, the video surveillance information is made available for immediate or delayed re-transmission as well as archived for future access. The ability to access the video surveillance information is governed by a set of rules enforced by the video surveillance service center.

The basis of the rules used by the surveillance service is the establishment of groups to which a user belongs. These groups may be based on geographical location, group affiliation, network of users, or otherwise. A user accessing other users' video surveillance information may or may not know these other users. In a typical scenario, a user would belong to a group based on his location. In other words, users that live in the same neighborhood would all belong to the same group. The surveillance service gives permission to the users belonging to the same group access to the video surveillance information from all the users of that group. Other rules that may be applied by the video surveillance service center to the access of video surveillance information are, for example, time of day/day of week access restrictions or access permission control to individual video surveillance information.

In FIG. 2, one user 250 is shown and is connected to the video surveillance service center 240 through connection over a network such as the Internet 230. This user is the owner or person responsible for the video surveillance system of location 1 (201). The user is also part of a group which also includes the locations 2 through n (211 and 221), where n can be any number. As such, the user is thus given the rights by the video surveillance service center 240 to access the video surveillance information from locations 1 through n. The user 250 in FIG. 2 is shown having 3 logical connections 251, 254 and 255 over the Internet 230 to the video surveillance service center to access the video surveillance information from three locations 201, 211 and 221. Physically, the connections are most likely one connection carrying the three different logical connections. Alternatively, the three logical connections shown may be one logical connection, carrying the video surveillance information for all three locations bundled together.

Because the user has access to the video surveillance information from all the other locations in the group, the effectiveness of the user's video surveillance system increases dramatically. Moreover, the security of the whole neighborhood is increased, helping reduce the amount of crime the neighborhood experiences.

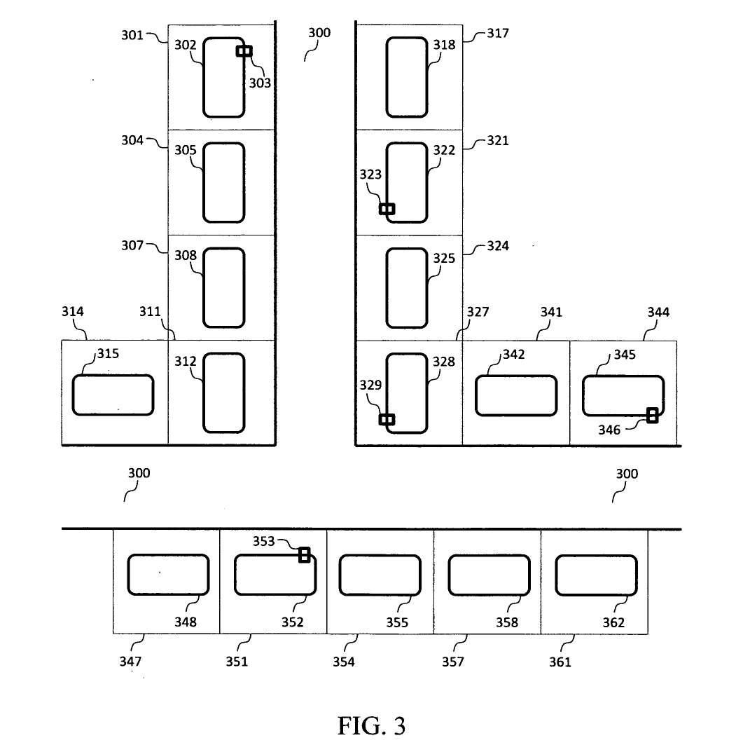

FIG. 3 further illustrates the invention, giving an example of the typical deployment of this invention, showing a possible physical relationship between the different locations. In FIG. 3, a street 300 is shown with the properties 301, 304, 307, 311, 314, 317, 321, 324, 327, 341, 344, 347, 351, 354, 357 and 361 along the street. On these properties, houses 302, 305, 308, 312, 315, 318, 322, 325, 328, 342, 345, 348, 352, 355, 358 and 362 are shown. On five of these houses, 302, 322, 328, 345 and 352, there are installed video surveillance cameras shown on the diagram (not to scale) as items 303, 323, 329, 346 and 353. In prior art, each home occupant owns his video surveillance camera and is the only one to have access, either locally onsite or through remote access, to the video surveillance information, which may be stored locally onsite or remotely at a server. In this invention, each of the home occupants 302, 322, 328, 345 and 352 subscribe to the same video surveillance service. At the video surveillance service center, these home occupants have each been placed in the same group based on their physical proximity to each other. By belonging to the same group and as permitted by the rules of the video surveillance service, each of these home occupants can access the video surveillance information of all of the home occupants in the group. As an example, home occupant 302 can access the video surveillance information from his video surveillance camera 303 as well as from the video surveillance cameras 323, 329, 346 and 353. This includes both real-time video, delayed video or archived video.

One can see from FIG. 3 the increased effectiveness of each of the individual video surveillance systems by the improvements enabled by this invention. This invention provides for a systematic method of allowing different home occupants or business owners in the same location to readily exchange video surveillance information through the use of a third-party video surveillance service. Thus each home or business owner can access many times more video surveillance information than if they did not utilize the method as outlined in this invention. One example of what can be gained from this additional video surveillance data is the ability for an occupant or owner to monitor beyond their immediate vicinity, gaining a much broader view of the neighborhood. With a broader view, occupants and owners can see potential security issues earlier. For any issues that do occur, occupants and owners can access the video surveillance information archived for a much broader area to enable better tracking of suspect individuals.

One improvement in the effectiveness of video surveillance through the use of this invention comes from the ability of a user to have access to video surveillance information to which he would normally not have access. With this additional video surveillance information, a user can better monitor live the neighborhood rather than just his immediate area. In addition, a user can have his home monitored live, or with a time delay, by his neighbors when he is not able to do so.

A second improvement in the video surveillance effectiveness is the availability to the user of stored video surveillance information from all the other users in his neighborhood. If an incident happens at a user's home, he can access not only the stored video surveillance information from his own video surveillance system but also the stored video surveillance information from the entire neighborhood. This assists in tracking the movements of any criminals through the neighborhood and can help lead to the arrest of the criminals. The arrest of a criminal after an incident in the neighborhood can lead to reduced incidents in the future.

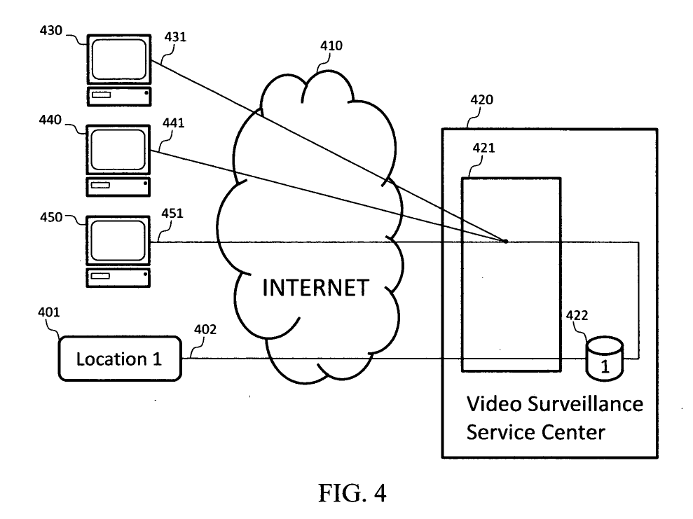

One feature of modern video surveillance systems is the use of email or text alerts which consist of an email or text being sent to the user when motion or some other pre-determined event occurs. These alerts can be simple text, or in the case of emails, also contain images and video clips from the time when the event occurred. The user, through network access (Internet access for emails and mobile access for text messages), can receive the alert where ever he is and, based on the information contained in the alert, take action as required. A third improvement from this invention is the broadcasting of these alerts to all the users in the group. For example, referring to FIG. 4, if motion is detected at location 401, an alert is sent to the video surveillance service center 420 by a connection through the Internet 410. At the video surveillance service center 420, the alert is processed by the computer system 421 and stored in the database 422. From there, the computer system 421 sends the alert to all the home occupants that belong to the group. In the example in FIG. 4, three occupants are accessing video surveillance information from the video surveillance center through Internet connections 431, 441 and 451. The alert is thus provided to the three users on their computers 430, 440 and 450 that they are using to access the video surveillance service center 420. While the home occupant of location 401 may possibly not be in a position to receive or act on the alert, the other occupants 430, 440 and 450 could. Being that these other occupants are typically neighbors, their response could be rather quick. Their response may be to contact the authorities, investigate in-person and/or to start monitoring the other neighborhood video surveillance information from location 401 live. Thus the effectiveness of the video surveillance system is improved by having a shared neighborhood response to an alert as provided by this invention.

Another improvement in video surveillance effectiveness from this invention is the ability of users in a group to share additional information in regards to neighborhood security besides the video security information. Examples of such information are advice and comments on security for the neighborhood. Typically such information would be exchanged through discussion groups or emails associated with the neighborhood group. In FIG. 4, for example, the users 430, 440 and 450, when all receiving the alert message from location 401, could immediately share information about the alert and discuss action they could take. The sharing of information between the users is enabled by the video surveillance service center 420. The information shared could be in the form of text, video, images or audio.

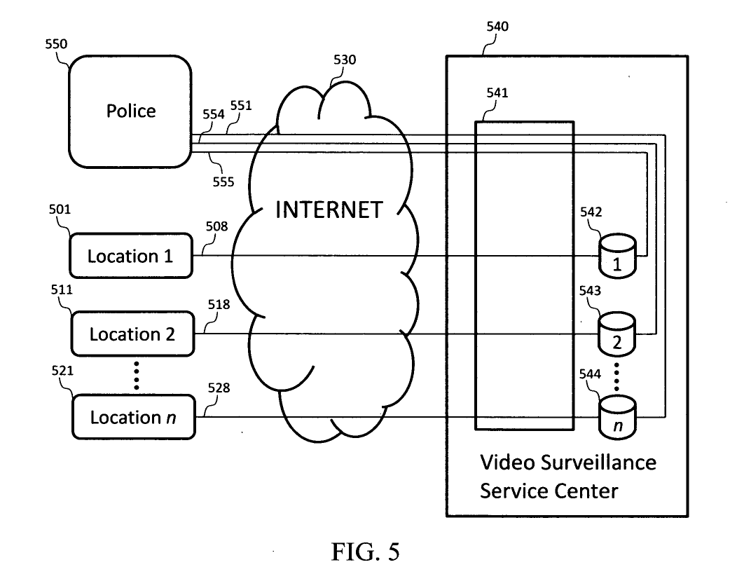

Another improvement in video surveillance effectiveness from this invention is to allow law enforcement agencies such as the police or other security services to access video surveillance information from users. In FIG. 5, the police 550 are shown connecting to the video surveillance center 540 by network connections 551, 554 and 555 through the Internet 530. The police have access to the video surveillance information from the locations 501, 511 and 521 through the video surveillance service center 540. This permission for the police to access video surveillance information may be pre-arranged by the service provider as part of its service terms, or the permission may be given by the groups, or by the individual users. With this broad neighborhood video surveillance information coming from a number of users in the same neighborhood, the tracking of criminals and suspicious activities in a neighborhood by the police is greatly facilitated. This in turn should lead to reduced crime in the neighborhood.

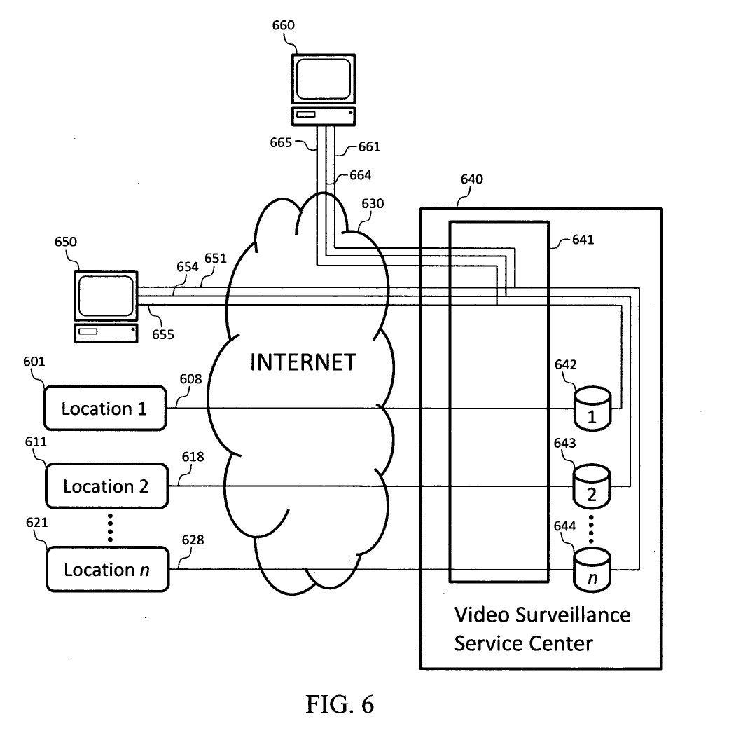

Another improvement in video surveillance effectiveness from this invention is the ability to delegate the monitoring of the video surveillance information. An owner of a video surveillance system can typically designate another person to connect to his video surveillance system in order to monitor the system on his behalf. With this invention, the designated person can monitor the video surveillance information from the entire group. FIG. 6 shows multiple locations with surveillance systems (601, 611 and 621) connected via broadband connections 608, 618 and 628 respectively through the Internet 630 to the video surveillance service center 640. The computer system 641 at the video surveillance service center 640 stores the video surveillance information from the monitored locations 601, 611 and 621 in the databases 642, 643 and 644. The occupant of one of the locations monitors the video surveillance information from a computer 650 connected to the Internet 630. This occupant is able to see the video surveillance information from all the locations in his group as specified by the rules at the video surveillance service center 640. This occupant may alternatively give authority or otherwise delegate the responsibility of monitoring the video surveillance information as shown in FIG. 6 to a person at computer 660. This designated person not only can monitor the video surveillance information for the one occupant, but all the video surveillance information from the multiple locations belonging to the same group. Thus, the likelihood that there is a user or designated person in the group monitoring the video surveillance information live increases dramatically as compared to separate individually monitored video security systems. The designated person can easily be located remotely through use of a network connection to access the video security information.

In another embodiment of this invention, the users in the same group can be businesses rather than home occupants. Businesses would typically be located in the same vicinity of each other and thus share in the security of their business area. With the shared video surveillance method as described by this invention, the businesses would benefit from the enhanced security provided by the sharing of video surveillance information.

With this invention, different types of video cameras and surveillance systems may be deployed by users belonging to the same surveillance group. The video surveillance service center accepts the video surveillance information in different formats and protocols as provided by the user's video surveillance system. Users within the same group may use different formats and protocols from each other. Hence, the video surveillance service center converts the formats and protocols to a format and protocol that all the users can use to view the video surveillance information from all the users.

In another embodiment of this invention, rather than all the video surveillance information being stored at the video surveillance service center, it remains stored on the individual user locations. The video surveillance service center, however, still controls the access a user has to other users' video surveillance information. As an example, if user 1 and user 2 belong to the same group, user 1 can access the video surveillance information located on the video surveillance system of user 2 through access permissions given by the video surveillance service center.

What is claimed is:

1. A method of sharing video surveillance information which comprises video surveillance information collected from multiple users who each use a video surveillance system independent from the other users, and stored on a third-party system from which users may access the video surveillance information they supplied in addition to video surveillance information provided by other independent users as determined by the third-party system.

2. The method of claim 1, wherein the video surveillance information may consist of video, images, audio, motion detection, fire detection and other such surveillance data.

3. The method of claim 1, wherein the users are home occupants.

4. The method of claim 1, wherein the users are business owners or business managers.

5. The method of claim 1, wherein the video surveillance information is collected from the users in real-time or after a delay.

6. The method of claim 1, wherein the video surveillance information is collected from the users across a public network such as the Internet.

7. The method of claim 1, wherein the video surveillance information is collected from the users across a private network.

8. The method of claim 1, wherein the video surveillance information is collected from the users across a mobile network.

9. The method of claim 1, wherein the video surveillance systems used by the users are analog based.

10. The method of claim 1, wherein the video surveillance systems used by the users are IP (Internet Protocol) based.

11. The method of claim 1, wherein the video surveillance systems used by the users are different from each other by way of camera models, camera manufacturers, video surveillance protocols and formats used to transmit and record video surveillance information.

12. The method of claim 1, wherein the third-party system is composed of computers, storage devices and software, and is either centrally located or distributed at different locations.

13. The method of claim 1, wherein the third-party system determines which users' video surveillance information a user can access based on a set of rules as established by the third-party system using such parameters as location of the users, time of day, day of week, level of service, account standing, and users' privacy settings.

14. The method of claim 1, wherein the video surveillance information is accessed from the third-party system in real-time, after a delay, or at a much later time where the video surveillance information can be browsed through slowly or quickly as determined by the user.

15. The method of claim 1, further comprising of the ability of users sharing video surveillance information to additionally share advice, comments and related surveillance and security information through the third-party system.

16. The method of claim 1, further comprising of the ability of law enforcement agencies and security services to connect to the third-party system and access the video surveillance information from the users on a voluntary or non-voluntary basis.

17. The method of claim 1, further comprising of the ability of a user to authorize another person or persons to access their video surveillance information in addition to the video surveillance information of other users to which they have access from the third-party system.

18. The method of claim 1, further comprising of the ability of the third-party system to accept the video surveillance information from the different video surveillance systems in different formats and protocols as well as the ability to convert between the different formats and protocols such that each user's video surveillance information can be seen by the other users.

19. A method of sharing video surveillance information which comprises of multiple users that each use a video surveillance system independent from the other users and store their own video surveillance information on their own video surveillance system from where they may access it and can also access the video surveillance information from the other independent users from their video surveillance systems.

20. The method of claim 19, further comprising of the ability of users sharing video surveillance information to additionally share advice, comments and related surveillance and security information directly with each other.

21. The method of claim 19, further comprising of the ability of law enforcement agencies to connect to the users and access the video surveillance information from the users on a voluntary or non-voluntary basis.

22. The method of claim 19, further comprising of the ability of a user to authorize another person or persons to access their video surveillance information in addition to the video surveillance information of other users to which they have access.
